(19) United States
(12) Patent Application Publication
(10) Pub. No.: US 2013/0270002 A1
(43) Pub. Date: Oct. 17, 2013

(54) CHARGE AND SYNC CABLES FOR MOBILE DEVICES

(71) Applicant: Jonathan Eric Fawcett, Stow, OH (US)

(72) Inventor: Jonathan Eric Fawcett, Stow, OH (US)

(21) Appl. No.: 13/826,379

(22) Filed: Mar. 14, 2013

Related U.S. Application Data
(60) Provisional application No. 61/643,695, filed on May 7, 2012.
(60) Provisional application No. 61/624,330, filed on Apr. 15, 2012.

(51) Int. Cl. H01R 11/01

(52) U.S. Cl. CPC H01R 11/01
USPC 174/84 S

(57) ABSTRACT

A charge and sync cable includes a length of generally hollow, semi-flexible conduit for positioning and supporting a mobile device at a desired location and orientation. The conduit contains a pair of conductors and has a first connector rigidly affixed at one end of the conduit and a second connector rigidly affixed at the other end of the conduit. The first connector may be a USB connector and the second connector may be an Apple® dock connector. Alternatively, the first connector may be a USB connector and the second connector may be a mini or micro USB connector. The conduit may have a male USB connector at one end for electrically coupling to an input jack of a central hub and a connecter, adapter or mobile accessory at the other end. The charge and sync cable may further include an adapter for a standardized cable having male USB connectors to electrically couple a mobile device having a different type of connector.

### CROSS REFERENCE To RELATED APPLICATIONS

This United States non-provisional application claims the benefit of priority of U.S. Provisional Application No. 61/643,695, filed on May 7, 2012, and U.S. Provisional Application No. 61/624,330, filed on Apr. 15, 2012.

### FIELD OF THE INVENTION

This invention relates generally to charge and sync cables for relatively small, portable, battery operated, electronic communications and computing devices, commonly referred to as “mobile devices.” Examples of mobile devices suitable for use with a charge and/or sync cable according to the invention include Personal Digital Assistants (PDAs), Global Positioning Satellite (GPS) devices, Personal Navigation Devices (PNDs), portable media players, handheld game consoles, small tablet computers, handheld digital cameras and video recorders, pagers, mobile telephones and Smartphones. In various exemplary embodiments, a charge and sync cable according to the invention includes a length of elongate, semi-flexible conduit containing at least two electrical conductors and having a connector on each end rigidly affixed to the semi-flexible conduit.

### BACKGROUND OF THE INVENTION

The use of mobile devices, and in particular Smartphones, has proliferated immensely in recent years. It is not unusual for an individual, such as a business person, to have several mobile devices available for use at the same time. Given the ever increasing need for mobility of people, and in particular business persons, as well as the continuing reduction in the size of communications and computing devices, it is certain that the use of mobile devices will continue to propagate in the future. However, several problems are inherent with the use of mobile devices, and more specifically, with the charging and syncing of mobile devices.

Being battery operated, mobile devices require continuous or periodic charging from an external source of power. Accordingly, manufacturers of mobile devices provide AC to DC power cords, commonly referred to as “chargers,” and docking stations for charging the various makes, models and brands of mobile devices. Certain mobile devices, such as Smartphones and mp3 audio players, also use a sync cable to synchronize digital data between the mobile device and, for example, a desktop or laptop computer. In some instances, the charging cable and the sync cable have been combined into a single cable, such as the Belkin 30 pin ChargeSync Cable configured to charge and sync iPhone®, iPad® and iPod® mobile devices manufactured by Apple Inc. of Cupertino, Calif. In other instances, a single cable has been configured with a combination connector to charge and sync mobile devices with either an Apple® 10-pin connector or a micro-USB connector, such as the jWIN® Premium Dual Jack Combination Charge and Sync Cable commercially available from jWIN Electronics Corporation of Port Washington, N.Y.

Being relatively small and handheld, mobile devices tend to be easily misplaced or lost, especially on a crowded desk or work area. In addition, mobile devices typically include a display made of glass or hard plastic that can be scratched or otherwise damaged when the mobile device is moved over a counter, table, desk or the like having an abrasive surface. Accordingly, manufacturers of mobile devices offer stands, including docking stations, for supporting the various makes, models and brands of mobile devices in a prominent manner that also protects the display of the mobile device from being scratched or otherwise damaged. The known stands and docking stations, however, are rigid, and therefore, position the mobile device in a particular orientation, which may not be convenient for viewing. In addition, the available stands and docking stations typically require the mobile device to be supported in a manner that makes it at best cumbersome, if not impossible, to access and operate certain of the features of the mobile device.

More and more mobile devices being introduced to the market are capable of being charged and synced from a standardized Universal Serial Bus (USB) port provided on a laptop or desktop computer. Accordingly, charge and sync cables exist that include a standardized USB connector on one end for engaging and electrically coupling with a USB port on a laptop or desktop computer. The other end of the charge and sync cable has a connector for engaging and electrically coupling with the power input port provided on the mobile device. In the past, the other end of the charge and sync cable required numerous different types of connectors to electrically couple with the particular type of power input port provided of the mobile device. More recently, however, manufacturers of mobile devices have increasingly configured the power input port of the mobile device for use with a smaller Apple type connector, or a standardized micro-USB plug type connector. These smaller type connectors, particularly on the power input port of the mobile device, are susceptible to being damaged if an excessive axial or bending force is applied to the connector.

Thus, it is apparent a need exists for a charge and sync cable for charging and/or syncing a mobile device in a manner that overcomes the aforementioned problems and deficiencies. There exists a further, and more specific, need for a charge and sync cable for use with a mobile device that positions the mobile device in a prominent location during charging and/or syncing so that the mobile device is not lost or misplaced. There exists a further, and more specific, need for a charge and sync cable for charging and/or syncing a mobile device that supports the mobile device in a convenient orientation, while protecting the display of the mobile device from being scratched or otherwise damaged. There exists a still further, and more specific, need for a charge and sync cable for use with a mobile device that does not subject the power input port of the mobile device to excessive axial or bending forces.

### BRIEF DESCRIPTION OF THE DRAWINGS

FIG. 1 is a perspective view of an exemplary embodiment of a charge and sync cable according to the invention.

FIG. 2 is an elevation view of the charge and sync cable of FIG. 1 taken from the left-hand side.

FIG. 3 is an elevation view of the charge and sync cable of FIG. 1 taken from the right-hand side.

FIG. 4 is a top plan view of the charge and sync cable of FIG. 1.

FIG. 5 is a perspective view of a central hub for use with a plurality of cables, including a charge and sync cable according to the invention.

FIG. 6 is an elevation view of the central hub and the plurality of cables of FIG. 5 taken from the front.

FIG. 7 is a perspective view of an exemplary embodiment of a means for rigidly affixing a connector to the conduit of a charge and sync cable according to the invention.

FIG. 8 is a perspective view of another exemplary embodiment of a means for rigidly affixing a connector to the conduit of a charge and sync cable according to the invention.

FIG. 9 is a perspective view of yet another exemplary embodiment of a means for rigidly affixing a connector to the conduit of a charge and sync cable according to the invention.

FIG. 10 is a perspective view of an exemplary embodiment of an adapter for use with a charge and sync cable according to the invention.

FIG. 11 is an elevation view of the adapter and the charge and sync cable of FIG. 10 taken from the left-hand side.

FIG. 12 is an elevation view of the adapter and the charge and sync cable of FIG. 10 taken from the right-hand side.

FIG. 13 is a plan view of the adapter and the charge and sync cable of FIG. 10 taken from the top.

FIG. 14 is a sectioned detail elevation view of the adapter of FIG. 10 taken from the left-hand side.

FIG. 15 is a sectioned detail elevation view of the adapter of FIG. 10 taken from the right-hand side.

### DETAILED DESCRIPTION OF EXEMPLARY EMBODIMENTS

The accompanying drawing figures, wherein like reference numerals denote like elements throughout the various views, illustrate one or more exemplary embodiments of a charge and sync cable according to the invention. In the exemplary embodiment shown and described herein, the charge and/or sync cable comprises a length of elongate, semi-flexible conduit containing at least two electrical conductors and having a connector at each end that is rigidly affixed to the semi-flexible conduit. As will be understood and appreciated by those skilled in the art, the charge and sync cable electrically couples a relatively small, portable, battery-operated electronic communications and/or computing device, referred to herein as a “mobile device,” to a standardized connector port of a charging and/or data synchronizing device, such as a Universal Serial Bus (USB) port of a computer, a charge and/or data hub or a docking station. Mobile devices of the type suitable for use with a charge and/or sync cable according to the invention include Personal Digital Assistants (PDAs), Global Positioning Satellite (GPS) devices, Personal Navigation Devices (PNDs), portable media players, handheld game consoles, small tablet computers, handheld digital cameras and video recorders, pagers, mobile phones and Smartphones.

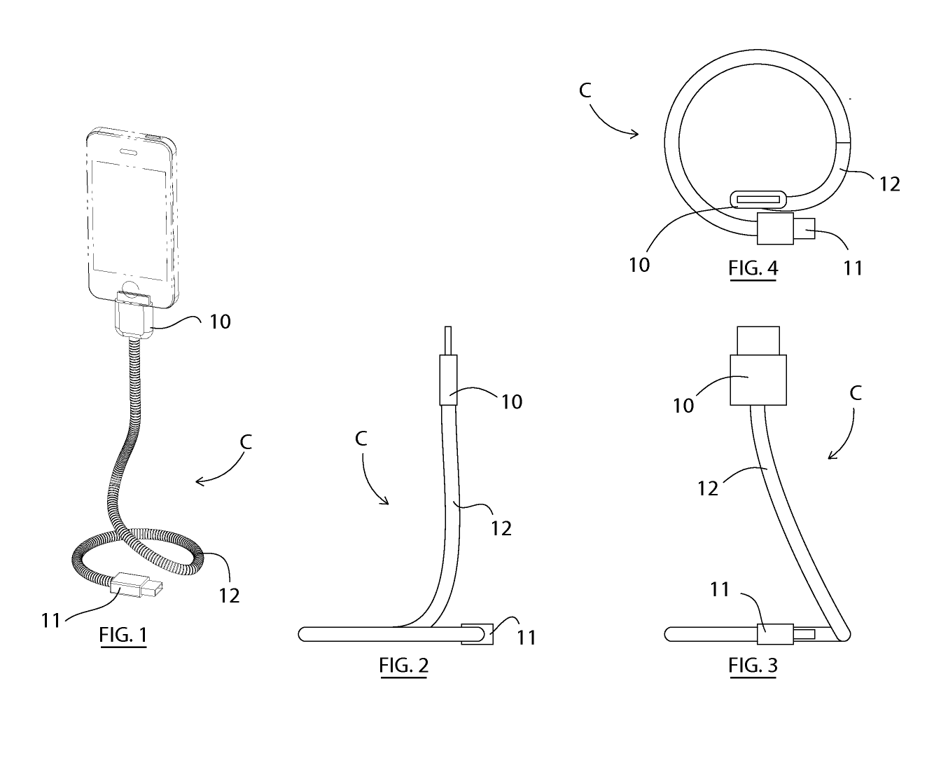

As shown in FIGS. 1-5, a charge and/or sync cable, indicated generally at C, comprises a predetermined length of an elongate, semi-flexible conduit 12. As used herein, the term “semi-flexible” is intended to mean that the conduit 12 of the cable C is flexible enough to allow a mobile device electrically connected to the cable to be positioned in a desired location and at a desired orientation, while being sufficiently rigid to support the weight of the mobile device in the desired location and orientation. As will be described in greater detail herein after, the cable C is also sufficiently rigid adjacent its opposite ends such that excessive axial and bending forces are not applied to a power input port of the mobile device. In a particularly advantageous embodiment, the conduit 12 is a generally hollow, flexible metal tube or outer sleeve of the type commonly referred to in the art as a “gooseneck.” A gooseneck conduit suitable for use with the cable C of the invention is commercially available in a variety of customized lengths and outer diameters ranging from about 2 mm to about 30 mm from Dongguan Shuangcheng Industrial Co., Ltd. Guandong, China. The Shuangcheng gooseneck is manufactured from spring wires, galvanized iron wires and stainless steel or copper tubing with a surface coating of silver plating, chrome plate, electrophoresis or baking for a black, white or colored finish.

A flexible gooseneck suitable for use with the invention has the necessary properties and functionality 1) to support an object with sufficient rigidity to withstand the weight of the object; 2) to hold the object in a desired position and orientation by maintaining a permissible bend radius; 3) to reposition the object; 4) to interconnect a pair of objects mechanically and electrically with conductors contained within the conduit; and 5) to provide a protective housing for protecting and shielding the conductors contained therein. It has been found determined that a generally hollow, flexible gooseneck having an outer diameter of between about 5 mm and about 9 mm provides sufficient flexibility (flexion) and rigidity (stiffness) for supporting, holding and repositioning mobile devices of the type contemplated by the invention. In a particularly preferred embodiment, the conduit 12 is made of a metal gooseneck having an outer diameter of between about 5.5 mm and about 6.0 mm. Regardless, the hollow, flexible conduit 12 houses and contains at least two electrical conductors for conducting an electrical power (charging) and/or data (syncing) signal to a mobile device.

The cable C further comprises a connector 10, 11 at each end of the conduit 12. As will be readily understood and appreciated by those skilled in the art, the connectors 10, 11 are rigidly affixed to the respective ends of the conduit 12. The rigidity of the conduit 12 and the connector 10 prevents the weight of the mobile device from being transferred to the connector and causing the connector to rotate (i.e. bend or twist) relative to the conduit while the mobile device is being positioned without support. Because the conduit 12 is rigid enough to support the weight of the phone and the connector 10 is rigidly affixed to the conduit, the position of the mobile device is based on the location of the connector rigidly affixed to the conduit. The same reasoning (i.e. the weight of the mobile device and conduit 12, including connectors 10, 11) applies to the rigidity of the conduit 10 and the connector 11 with respect to computer, hub or other charging and/or data synchronizing device. Connector 10 may be any commonly used type of connector for electrically coupling with the power input and/or data port of a mobile device. In the exemplary embodiments herein, connector 10 is shown for purposes of illustration only as a conventional proprietary 30 pin dock connector provided on Apple® iPhone®, iPad® and iPod® mobile devices. However, in preferred embodiments of the invention connector 10 may also be the more recently introduced Lightning® 8 pin dock connector provided on the Apple® iPhone5®, or alternatively, a micro-USB connector utilized extensively with mobile devices manufactured by others. It is envisioned that connector 10 may be a standardized type of connector that is compatible with a majority of the mobile devices available on the market, and further, that multiple charge and sync cables C comprising different types of connectors 10 will be required for the various commercially available mobile devices.

Likewise, connector 11 may be any type of connector commonly used for electrically coupling with the power output and/or data port of a computer, a charge and/or data hub, a docking station or any other charging and/or data synchronizing device. In the exemplary embodiments herein, connector 11 is illustrated as a standard USB connector of the type commonly provided on computers (e.g. desktops, laptops, tablets), hubs and other charging and data synchronizing devices. However, it is envisioned that connector 11 may be any standardized type of connector that is compatible with a majority of the mobile devices available on the market, and further. It is further envisioned that multiple charge and sync cables C comprising different types of connectors 11 will be required for the various commercially available computers (e.g. desktop, laptop, tablet, etc.), hubs and other charging and data synchronizing devices.

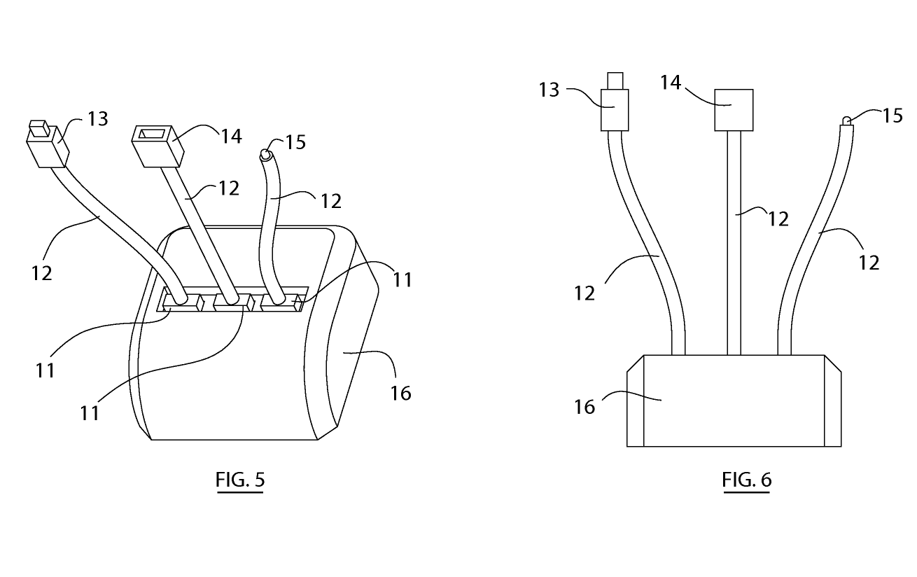

FIG. 5 and FIG. 6 show a central hub 16 for use with one or more cables C comprising a conduit 12 having a connector 11 rigidly affixed at one end of the conduit. The central hub 16 provides sufficient weight and center of gravity to support and position multiple mobile devices and includes a plurality of recessed input jack for receiving the connectors 11 of a corresponding plurality of the cables C. The other end of the conduit 12 is provided with a connector 13, adapter 14, or mobile accessory 15, as desired. As shown in the exemplary embodiments herein, one of the cables C is provided with a USB connector 11 at one end of the conduit 12 electrically connected to an input jack of the central hub 16 and a mini or micro USB connector 13 rigidly affixed to the other end of the conduit. Another of the cables C is provided with a USB connector 11 at one end of the conduit 12 electrically connected to an input jack of the central hub 16 and a female USB connector or adapter 14 at the other end. Yet another of the cables C is provided with a USB connector 11 at one end of the conduit 12 electrically connected to an input jack of the central hub 16 with a mobile accessory, for example LED light accessory, 15 at the other end. Accordingly, exemplary uses for the cables C and the central hub 16 of the invention include charging and syncing an Apple® iPhone® using the proprietary Apple® connector 10, charging and syncing Android® and other mobile telephones using the mini or micro connector 13, attaching other portable mobile devices having a male USB connector or adapter to the central hub 16 using the female USB connector or adapter 14, and powering and positioning an LED light accessory 15 from the central hub 16.

In view of the foregoing, it will be readily apparent to those skilled in the art that a charge and/or sync cable C according to the invention having a semi-flexible conduit 12 provides the ability to easily, readily and freely position an electronic mobile device at a convenient location and in a convenient orientation for viewing and operating the mobile device. Charge and/or sync cables C according to the invention further provide increased and improved usability of the functionality of mobile devices, and particularly, Smartphones such as Apple® and Android® mobile phones. For example, video-conferencing is enhanced because the cable C allows the Smartphone to be located and oriented in an optimal position for the transmitting video camera and the receiving video display. For photography and videography applications, the cable C allows for stable position of the Smartphone, handheld digital camera or video recorder similar to that provided by a conventional camera tripod. Thus, the primary utility of a cable C according to the invention is to provide adjustable placement of a mobile device during charging, data synchronizing or use by means of a semi-flexible conduit 12 having connectors rigidly affixed to the ends of the conduit such that the cable is strong enough to support the weight and other forces exerted by the mobile device, yet remains flexible enough to easily, readily and freely position the mobile device without the need for an additional stand, dock or other mechanical or structural apparatus.

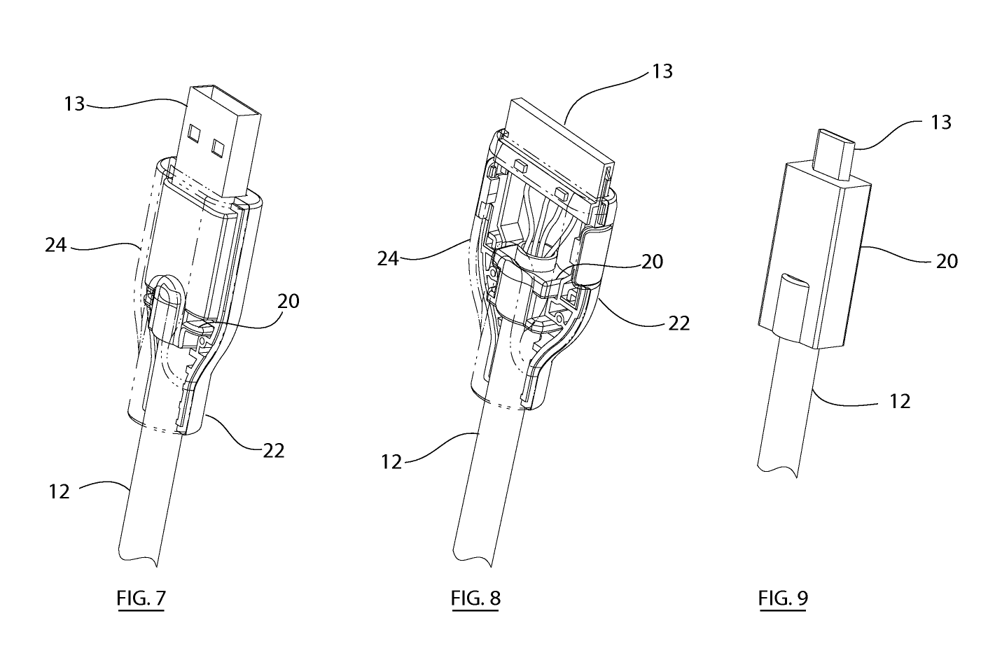

FIGS. 7-9 show various means for rigidly affixing any one of the connectors 10, 11, 13, adapter 14 or mobile accessory 15 to the conduit 12 of a cable C according to the invention. Any suitable means for rigidly affixing the connectors 10, 11, 13, adapter 14 or mobile accessory 15 to conduit 12 is intended to be encompassed by the invention. In a particularly advantageous embodiment illustrated in FIG. 7, the male engaging and conducting member of a standard USB-A connector 13 is over-molded with a relatively hard plastic over-molding material 20, for example a thermoplastic elastomer (TPE), onto an end of the conduit 12. An injection molded lower housing 22 and a complementary injection molded upper housing 24 are then positioned over the over-molding material 20 with the male engaging and conducting member of the connector 13 extending outwardly therefrom and secured together, for example by ultrasonic welding, around the end of the gooseneck conduit 12. In this manner, any excessive axial or bending forces applied to the connector 13 of the cable C by the mobile device will be stress relieved by the over-molding material 20 and will not cause the connector 13 to rotate relative to the conduit 12.

In the advantageous embodiment of FIG. 8 illustrating an Apple® dock connector, only the end of the gooseneck conduit 12 is over-molded with the over-molding material 20 and the injection molded lower housing 22 and injection molded upper housing 24 secure (lock) the connector 13 on the end of the conduit by means of locking tabs or the like. In the advantageous embodiment of FIG. 9 illustrating a standard micro-USB connector, the lower housing 22 and the upper housing 24 are eliminated and only the end of the gooseneck conduit 12 is over-molded with the over-molding material 20 around the connector 13. In yet another embodiment (not shown), the over-molding material 20 is eliminated and the lower housing 22 and upper housing 24 are secured, for example by gluing, around the end of the gooseneck conduit 12 and the connector 13. It should be noted that the proprietary Apple® connector 10 and the USB connector 11 configured for electrically coupling to a computer, hub, docking station or the like, preferably are likewise rigidly affixed to the opposite other end of the gooseneck conduit 12 in any one of the aforementioned manners.

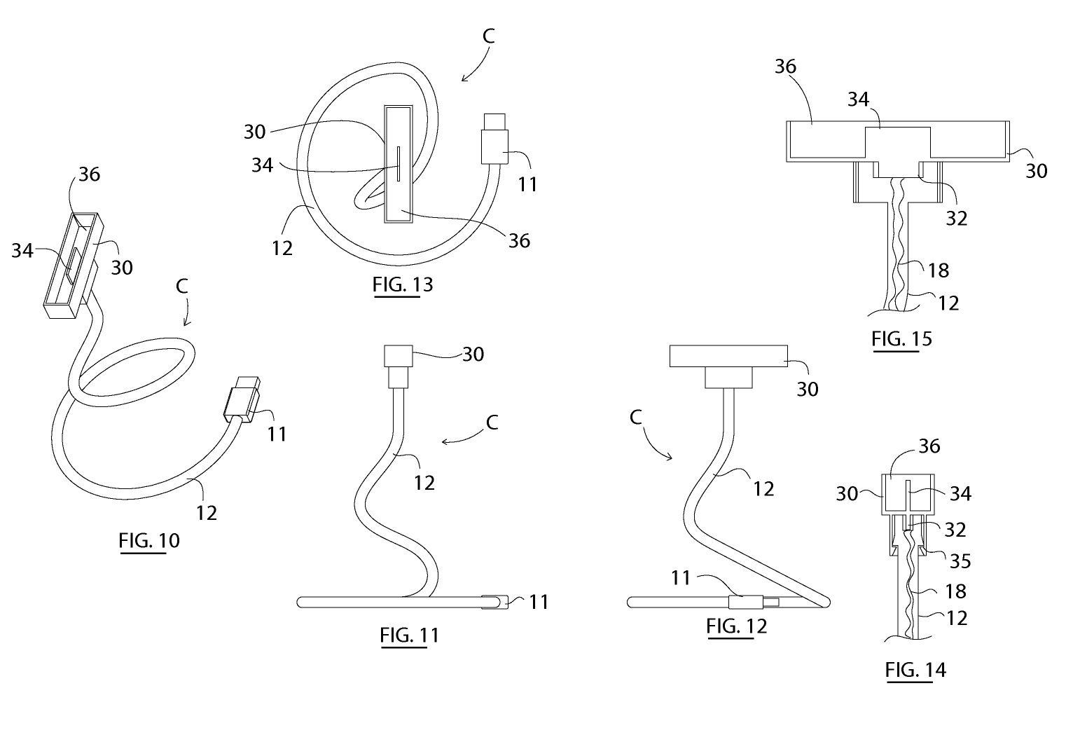

FIGS. 10-15 show an adapter 30 for use with a charge and/or sync cable C according to the invention. The adapter 30 permits a standardized cable C comprising a semi-flexible conduit 12 having a USB connector 11 rigidly affixed to the conduit at both ends to be electrically coupled to a mobile device having a power input port configured with any type of connector. A standard male USB connector 11 rigidly affixed to each end of the conduit 12 of cable C is shown herein for purposes of illustration only. One of ordinary skill in the art will readily understand and appreciate that connector 11 may be any other standardized connector, and further, conduit 12 may comprise a different type of standardized connector at either end. As shown herein for purposes of illustration, the adapter 30 may be configured to permit a mobile device having a proprietary Apple® connector to be electrically coupled to the charge and/or sync cable C. Conductors 18 contained within the conduit 12 (see FIG. 14 and FIG. 15) are electrically connected to the male USB connectors 11 at the ends of the conduit in a conventional manner and the connectors 11 are rigidly affixed to the conduit, as previously described. The adapter 30 comprises a housing having a female USB connector 32 on one side of the housing integrally formed with a preselected different type of male connector 34 on the opposite side. The female USB connector 32 mates with the male USB connector 11 provided on the conduit 12 of the cable C and conducts electrical signals from the conductors 18 to the male connector 34 on the opposite side of the housing.

In the exemplary embodiments shown and described herein, the housing of the adapter 30 attaches mechanically to the outer structure of the USB connector 11, for example by molded snaps, fasteners or the like 35. Regardless, the attachment means 35 of the adapter 30 provide sufficient strength and rigidity (stiffness) for holding the mobile device in any desired location and orientation. The male connector 34 mates to a power input port of a mobile device configured with a corresponding female connector to deliver electrical power signals and/or data signals to the mobile device in a conventional manner. If desired, the length, width and depth dimensions of the housing of the adapter 30 may be selected so as to define an internal compartment 36 for receiving a portion of the mobile device therein to further support the mobile device in the desired location and orientation. In addition, the male connector 34 of the adapter 30 may be located on the front (i.e. top) or either side of the housing to accommodate mobile devices having a power input port with a corresponding female connector of the same type in different locations and positions on the mobile device.

The foregoing has described one or more exemplary embodiments of a charge and/or sync cable C including a semi-flexible conduit 12 having a USB connector 11 rigidly affixed at one end of the conduit and a connector 10, 13, adapter 14 or mobile accessory 15 rigidly affixed at the other end of the conduit. The foregoing has also disclosed a central hub having a plurality of input jacks for receiving a corresponding plurality of cables C having a rigidly affixed USB connector 11 at one end and a rigidly affixed connector 10, 13, adapter 14 or mobile accessory 15 at the other end. In one embodiment, the connector 10, 11, 13 is rigidly attached to the conduit 12 by over-molding the conduit with an over-molding material 20 and thereafter securing a lower housing 22 and an upper housing 24 around the over-molding material. The foregoing has also described one or more exemplary embodiments of an adapter 30 configured with a female USB connector disposed on one side of a housing and a male connector of a different type disposed on the other side of the housing for electrically coupling to a mobile device having a power input port with a corresponding female connector. Exemplary embodiments of charge and/or sync cables C according to the invention have been shown and described herein for purposes of illustrating and enabling the best mode of making, using practicing the invention. Those of ordinary skill in the art, however, will readily understand and appreciate that numerous variations and modifications of the invention may be made without departing from the spirit and scope thereof. Accordingly, all such variations and modifications are intended to be encompassed by the appended claims.

That which is claimed is:

1. A charge and sync cable for a mobile device, comprising:
a generally hollow, semi-flexible conduit containing a pair of conductors for conducting at least one of an electrical power signal and a data synchronization signal;
a first connector at one end of the conduit configured to be electrically coupled to an external source of electrical power; and
a second connector at the other opposite end of the conduit configured to be electrically coupled to the mobile device;
wherein the first connector and the second connector are rigidly affixed to the one end and the opposite other end of the conduit, respectively; and
wherein the conduit is sufficiently flexible to position the mobile device in a desired location and orientation, yet is sufficiently rigid to support the weight of the mobile device in the desired location and orientation.

2. A charge and sync cable according to claim 1, wherein the conduit comprises a flexible gooseneck.

3. A charge and sync cable according to claim 1, wherein the conductors are electrical conductors.

4. A charge and sync cable according to claim 1, wherein the first connector is a male USB connector.

5. A charge and sync cable according to claim 1, wherein the second connector is selected from the group consisting of a connector, an adapter and a mobile accessory.

6. A charge and sync cable according to claim 5, wherein the connector is selected from the group consisting of a 30 pin dock connector, an 8 pin dock connector, a mini USB connector and a micro USB connector.

7. A charge and sync cable according to claim 1, further comprising a central hub having at least one input jack configured to receive the first connector rigidly affixed at the one end of the conduit.

8. A charge and sync cable according to claim 7, wherein the central hub comprises a plurality of input jacks each configured to receive the first connector of a corresponding plurality of cables rigidly affixed at the one end of the conduit.

9. A charge and sync cable according to claim 8, wherein the first connector of the corresponding plurality of cables is a male USB connector and the second connector rigidly affixed at the other end of the conduit is selected from the group consisting of a connector, an adapter and a mobile accessory.

10. A charge and sync cable according to claim 1, wherein at least one of the first connector and the second connector is rigidly affixed to the conduit by an over-molding material that over-molds the connector and the end of the conduit.

11. A charge and sync cable according to claim 10, further comprising a lower housing and an upper housing that are secured together around the over-molding material.

12. A charge and sync cable according to claim 1, wherein at least one of the first connector and the second connector is rigidly affixed to the conduit by a lower housing and an upper housing that are secured together around the connector.

13. A charge and sync cable according to claim 1, further comprising an adapter for electrically coupling the mobile device to a standardized cable wherein the first connector and the second connector are the same type of connector.

14. A charge and sync cable according to claim 13, wherein the first connector of the standardized cable is a male USB connector and the second connector of the standardized cable is a male USB connector.

15. A charge and sync cable according to claim 13, wherein the adapter comprises a housing having a female connector on one side of the housing integrally formed with a male connector of a different type on the other side of the housing.

16. A charge and sync cable according to claim 15, wherein the female connector on the one side of the housing of the adapter is a female USB connector and the male connector on the other side of the housing of the adapter is selected from the group consisting of a 30 pin dock connector, an 8 pin dock connector, a mini USB connector and a micro USB connector.

17. A charge and sync cable according to claim 15, wherein the length, width and depth dimensions of the housing of the adapter are sized to receive and secure a portion of the mobile device therein.

18. A charge and sync cable according to claim 1, wherein the conduit has an outer diameter between about 5 mm and about 9 mm.

19. A charge and sync cable according to claim 17, wherein the outer diameter of the conduit is between about 5.5 mm and about 6.0 mm.

20. A charge and sync cable according to claim 2, wherein the flexible gooseneck is made of a metal selected from the group consisting of spring wires, galvanized iron wires, stainless steel tubing and copper tubing.
